(19) United States
(12) Patent Application Publication
(10) Pub. No.: US 2024/0094089 A1
(43) Pub. Date: Mar. 21, 2024

(54) METHOD FOR MONITORING THE STATE OF MECHANICAL COMPONENTS ON A SHAFT LINE, ASSOCIATED MONITORING DEVICE AND SYSTEM

(71) Applicant: SAFRAN, Paris (FR)

(72) Inventors: Amadou ASSOUMANE, Moissy-Cramayel (FR); Dany ABBOUD, Moissy-Cramayel (FR); Mohammed EL BADAOUI, Moissy-Cramayel (FR)

(73) Assignee: SAFRAN, Paris (FR)

(21) Appl. No.: 18/262,454

(22) PCT Filed: Jan. 19, 2022
(86) PCT No.: PCT/FR2022/050103

§ 371 Date: Jul. 21, 2023

(30) Foreign Application Priority Data
Jan. 25, 2021 (FR) 2100663

(51) Int. Cl. G01M 13/045; G01M 15/14

(52) U.S. Cl. CPC G01M 13/045; G01M 15/14

(57) ABSTRACT

The invention relates to a method for monitoring the state of mechanical components such as bearings and gears on a shaft line equipping a rotating machine. Said method includes a step of obtaining at least one measurement yc[k] of the absolute acceleration of the shaft, as well as a set of steps of: obtaining a value fr[k] of the rotational frequency of the shaft, determining a matrix H[k] making it possible to define a state model described by: [k+1]=x[k]+w[k]etY[k]=[(y_c [k])¦SE[k]]=H[k]×x[k]+v[k], determining an estimator of the vector x[k] based on data from the state model, said set of steps further including, for at least one mechanical component, steps of: determining, from said estimator, a quantity characteristic of a contribution of said component to the vector Y[k], comparing said quantity with a threshold, detecting a possible defect of said at least one mechanical component.

### PRIOR ART

The present invention belongs to the general field of the monitoring and the predictive maintenance of mechanical components. It more particularly relates to a method for monitoring the state of mechanical components such as bearings and gears on a shaft line integrated to a rotating machine. It also relates to a monitoring device and system configured to implement such a monitoring method. The invention finds a particularly advantageous application, although without limitation, in the context of real-time monitoring of the state of health of such mechanical components, in particular when the rotating machine concerned is an aircraft engine.

The shaft Lines integrated into rotating machines are, conventionally, equipped with different mechanical parts or components, such as bearings and gears. It should be noted that the expression “rotating machine” conventionally refers to a machine whose kinematics obeys the physics of the rotating masses, and as such relates to any rotating system such as, for example, electric motors, turbomachines, electromechanical actuators, wind turbines, etc.

The monitoring of the state of health of such mechanical components plays a fundamental role, on the one hand, in ensuring a good lifespan of the shaft line equipped therewith (and subsequently of the rotating machine to which said shaft line is integrated), but also on the other hand in avoiding any incident, or even accident, whose origin could be related to excessive wear of said mechanical components.

It is therefore understood that to avoid the aforementioned inconveniences, and more generally to ensure early detection of any defects that may affect said mechanical components, it is of prime importance to ensure regular monitoring of their state of health.

For this purpose, there are known devices able to continuously monitor rotating machines by vibration analysis. Such devices schematically operate from vibration measurements taken for example by means of accelerometers placed on structural elements equipping these machines. These vibration measurements can also be completed by the use of displacement sensors able to measure the relative displacement of the shaft with respect to said structural elements. When the vibration measurements are taken, a frequency analysis of the recorded spectrum is then used, starting from the principle that a malfunction of a mechanical component can be identified there, for example by means of an evaluation of the amplitude of spectral lines characterizing the kinematics of the mechanical component in question. In this way, it is possible to check over time the operating state of one or more components on a shaft line.

The fact remains that the vibration analysis as described above remains poorly adapted to the monitoring of rotating equipment whose rpms are not stationary (under load and rotational speed), which makes it practically inapplicable to a large part of rotating machines. This concerns in particular the field of aeronautics where the rotating machines in question are operated according to large rpm variations (example: aircraft engines, particularly including turbomachines, during the take-off and landing phases).

Some relatively recent technical developments have then been proposed to allow a monitoring of the state of the mechanical components in real time and adapted to the variable rpms. The fact remains that such developments are still far from being considered as satisfactory. Their implementation can indeed be envisaged only for rotational speeds of a shaft that are less than 60 revolutions per minute, effectively excluding any application where such a constraint is not respected (therefore particularly in the field of aeronautics).

### DISCLOSURE OF THE INVENTION

The purpose of the present invention is to overcome all or part of the drawbacks of the prior art, in particular those set out above, by proposing a solution that makes it possible to monitor accurately and in real time the state of mechanical components such as bearings and gears on a shaft line equipping a rotating machine. Furthermore, the solution proposed by the invention makes it possible to carry out said monitoring in variable rpm and without limitation concerning the rotational speed of the shaft, so that it can be advantageously implemented for any technical field requiring the use of rotating machines.

To this end, and according to a first aspect, the invention relates to a method for monitoring the state of mechanical components such as bearings and gears on a shaft line equipping a rotating machine. Said method includes a step of obtaining at least one measurement y_{c}[k], k being an integer index, of the absolute acceleration of the shaft in a fixed reference frame related to the rotating machine, as well as a set of steps of:
obtaining a value fᵣ[k] of the rotational frequency of the shaft for an instant in which said at least one measurement y_{c}[k] was previously acquired,
determining a matrix H[k] allowing to define a state model described by:

$$x [ k + 1 ] = x [ k ] + w [ k ] and Y [ k ] = [ \begin{matrix}{y}_{c} [ k ] \\ SE [ k ]\end{matrix} ] = H [ k ] \times x [ k ] + v [ k ]$$

where w[k] is a random noise and v[k] is a noise associated with said at least one measurement y_{c}[k], H[k] is defined from the value fᵣ[k], SE[k] is equal to the expectation of the product between y_{c}[k] and the conjugate value of y_{c}[k], x[k] is a vector including, for each mechanical component, a sub-vector whose components are representative of a contribution of said mechanical component to the vector Y[k],
determining an estimator of the vector x[k] from said matrix H[k],

said set of steps further including, for at least one mechanical component, steps of:
determining, from said estimator, a quantity characteristic of said contribution associated with said mechanical component,
detecting a possible defect of said at least one mechanical component as a function of a comparison of said quantity with a threshold.

The monitoring method proposed by the invention is therefore based on the use of the state model which makes it possible to represent (model) the respective contributions of the mechanical components of the shaft line to the vibrations undergone by said shaft during the operation of the rotating machine.

More specifically, the contributions associated with the gear-type mechanical components are at the level of the component y_{c}[k] of the vector Y[k], while the contributions associated with bearing-type components are at the level of the component SE[k] of said vector Y[k]. In other words, the vector Y[k] forms a representation of the kinematics of the mechanical components whose state should be monitored.

Such an approach to modeling the vibration behavior of the shaft, and therefore a fortiori of the mechanical components that equip it, makes it possible to advantageously distinguish the present invention from the state of the art. Indeed, by proceeding in this way, it is no longer necessary to limit the monitoring of the mechanical components to rotational speeds of a shaft that are less than 60 revolutions per minute. The method according to the invention therefore makes it possible to carry out said monitoring whatever the rotational speed of the shaft. It is further independent of the operating rpm of the rotating machine, and can therefore be implemented in the case of a variable rpm.

The monitoring method according to the invention also offers the possibility of implementing the steps necessary for the detection of any in defects in the mechanical components after each time an absolute acceleration measurement of the shaft is obtained. This results in the possibility of establishing a simultaneous and real-time monitoring of the state of said mechanical components, thus contributing to the early detection of possible defects.

Finally, an additional advantage of the monitoring method according to the invention is due to the robustness of the estimator of the vector x[k] which is determined. This robustness stems from the fact that no assumption is made on the statistical nature of the noises of the state model and in that the estimator takes into account not only the errors related to the measurements but also the errors related to the modeling, as such, of the state model.

In particular modes of implementation, the monitoring method can further include one or more of the following characteristics, taken in isolation or according to all technically possible combinations.

In particular modes of implementation, the estimator of the vector x[k] is determined by means of a minimax optimization algorithm or a least squares optimization algorithm.

In particular modes of implementation, said quantity is representative of an amplitude or a phase or an energy of said contribution.

In particular modes of implementation, said method further includes, if a defect is detected, a step of issuing an alert.

The fact of issuing an alert in case of a positive detection of a defect makes it possible to obtain without delay information as to the existence of said defect.

In particular modes of implementation, a plurality of absolute acceleration measurements are obtained recurrently, said set of steps being implemented after each time an absolute acceleration measurement is obtained.

According to another aspect, the invention relates to a computer program including instructions for the implementation of a monitoring method according to the invention when said computer program is executed by a computer.

This program can use any programming language, and be in the form of source code, object code, or intermediate code between source code and object code, such as in partially compiled form or in any other desirable form.

According to another aspect, the invention relates to a computer-readable information or recording medium on which a computer program according to the invention is recorded.

The information or recording medium can be any entity or device capable of storing the program. For example, the medium can include a storage means, such as a ROM, for example a CD ROM or a microelectronic circuit ROM, or a magnetic recording means, for example a floppy disk or a hard disk.

On the other hand, the information or recording medium can be a transmissible medium such as an electrical or optical signal, which can be conveyed via an electrical or optical cable, by radio or by other means. The program according to the invention can be particularly downloaded from an Internet-type network.

Alternatively, the information or recording medium can be an integrated circuit in which the program is incorporated, the circuit being adapted to execute or to be used in the execution of the method in question.

According to another aspect, the invention relates to a device for monitoring the state of mechanical components such as bearings and gears on a shaft line equipping a rotating machine. Said processing device includes:
a. a first obtaining module configured to obtain at least one measurement y_{c}[k], k being an integer index, of the absolute acceleration of the shaft in a fixed reference frame related to the rotating machine,
b. a second obtaining module configured to obtain a value fᵣ[k] of the rotational frequency of the shaft for an instant in which said at least one measurement y_{c}[k] was acquired,
c. a first determination module configured to determine a matrix H[k] making it possible to define a state model described by:

$$x [ k + 1 ] = x [ k ] + w [ k ] and Y [ k ] = [ \begin{matrix}{y}_{c} [ k ] \\ SE [ k ]\end{matrix} ] = H [ k ] \times x [ k ] + v [ k ]$$

where w[k] is a random noise and v[k] is a noise associated with said at least one measurement y_{c}[k], H[k] is defined based on the value fᵣ[k], SE[k] is equal to the expectation of the product between y_{c}[k] and the conjugate value of y_{c}[k], x[k] is a vector including, for each mechanical component, a sub-vector whose components are representative of the contribution of said mechanical component to the vector Y[k],
a second determination module configured to determine an estimator of the vector x[k] from said matrix H[k],
a third determination module configured to determine, from said estimator, at least one quantity characteristic of said contribution associated with a mechanical component,
a comparison module configured to compare said at least one quantity with a threshold, so as to obtain a comparison result,
a detection module configured to detect a possible defect of said at least one mechanical component based on the comparison result.

According to another aspect, the invention relates to a system for monitoring the state of mechanical components such as bearings and gears on a shaft line equipping a rotating machine. Said monitoring system includes:
a. means for acquiring at least one measurement y_{c}[k], k being an integer index, of the absolute acceleration of the shaft in a fixed reference frame related to the rotating machine,
b. a monitoring device according to the invention.

Finally, according to a last aspect, the invention relates to an aircraft including a monitoring system according to the invention.

### BRIEF DESCRIPTION OF THE DRAWINGS

Other characteristics and advantages of the present invention will become apparent from the description given below, with reference to the appended drawings which illustrate an exemplary embodiment without any limitation. In the figures:

FIG. 1 schematically represents, in its environment, one particular embodiment of a monitoring system according to the invention, said monitoring system being configured to monitor the state of mechanical components such as bearings and gears on a shaft line of an aircraft engine;

FIG. 2 schematically represents an example of hardware architecture of a monitoring device according to the invention belonging to the monitoring system of FIG. 1;

FIG. 3 represents, in the form of a flowchart, one particular mode of implementation of a monitoring method according to the invention by the monitoring device of FIG. 2.

### DESCRIPTION OF THE EMBODIMENTS

The present invention is described here in the context of an application to the field of aeronautics, more particularly that of the monitoring and predictive maintenance of mechanical components such as bearings and gears of a shaft line equipping an aircraft engine.

For the rest of the description, it is considered without limitation that said aircraft is of the airplane type, for example a civil airplane able to transport passengers and equipped with a plurality of identical engines of the turbine engine type. By way of example, said engines are turbojet engines.

Nothing excludes however, according to other examples not detailed here, considering other types of turbine engines, such as for example a turboprop, but also, and in a more general way, engines which are not turbine engines, such as piston engines. The invention is indeed applicable to any type of aircraft engine including a shaft line on which mechanical components such as bearings and gears are arranged, and the state of which is to be monitored over time as described in detail later. Of course, nothing excludes considering an aircraft of another type, such as for example a helicopter.

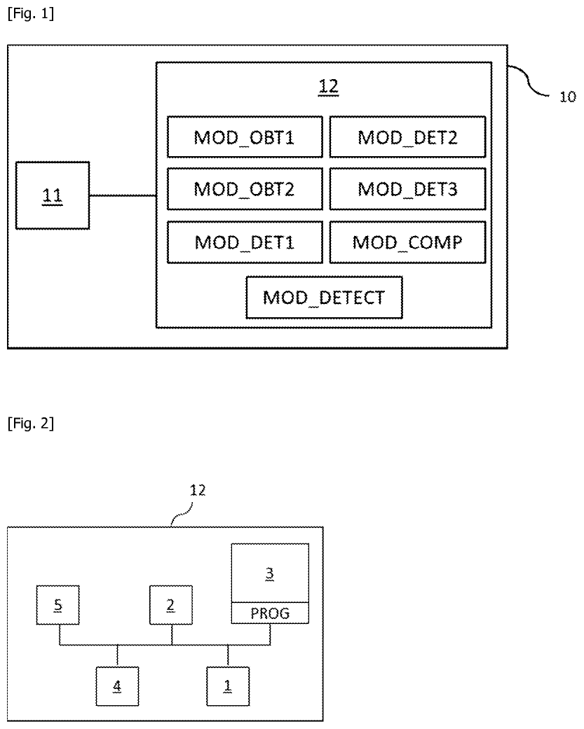

FIG. 1 schematically represents, in its environment, one particular embodiment of a monitoring system 10 according to the invention.

Said monitoring system 10 is configured to monitor the state of mechanical components such as bearings and gears on the shaft line of the aircraft engine. To this end, said system 10 includes acquisition means 11 configured to acquire:
c. at least one measurement y_{c}[k] of the absolute acceleration of the shaft in a fixed reference frame related to the engine of the aircraft (k being an integer index indicating an acquisition rank among a series of absolute acceleration measurements),
d. at least one measurement vᵣ[k′] of the rotational speed of the shaft (k′ being an integer index indicating an acquisition rank among a series of rotational speed measurements).

By “absolute acceleration”, reference is conventionally made here to the overall acceleration of the shaft, that is to say the acceleration reflecting the vibrations undergone by the shaft due to the fact that the latter is secured to the engine of the aircraft. Said absolute acceleration being defined in a fixed reference frame related to the engine of the aircraft, it is of course understood that it remains independent of the speed of displacement of said aircraft.

Conventionally, said acquisition means 11 include an acquisition chain comprising at least a sensor dedicated to the absolute acceleration measurements y_{c}[k], such as for example an accelerometer of a design known per se, and at least a sensor dedicated to the measurements vᵣ[k′] of the rotational speed of the shaft, such as for example an optical encoder or even a tachometer. Said acquisition chain also includes other elements, such as in particular an acquisition card, electronic amplification and/or filtering means, an analog-digital converter, etc. These aspects are not further detailed here because they depart from the scope of the present invention.

In general, those skilled in the art know how to carry out and acquire measurements of the absolute acceleration and rotational speed of the shaft, and therefore know, in particular, how to choose suitable sensors for each of the considered magnitudes (absolute acceleration, rotational speed), for example in the catalogs of the products offered by specialized manufacturers. They also know how to position these sensors as well as how to choose a sampling frequency to acquire the measurements concerned. By way of non-limiting example, the sampling frequency is chosen so as to be at least ten times greater than the maximum frequency of the absolute acceleration/rotational speed signal obtained thanks to the sensors dedicated to the acquisition of this signal.

Ultimately, and at the output of said acquisition means 11, the acquired absolute acceleration/rotational speed measurements correspond to digital data forming a sampled signal that can be processed by computer means to monitor the state of the mechanical components arranged on the rotating shaft, as described in more detail below.

It should be noted that, for the remainder of the description, reference is made indifferently to “measurements y_{c}[k]” or to “a sampled signal y_{c}” (a sample of this signal therefore corresponding to a measurement y_{c}[k]), these two expressions having the same meaning. Of course, such a remark is also valid with regard to the measurements vᵣ[k′] of the rotational speed of the shaft.

The absolute acceleration/rotational speed measurements acquired by the acquisition means 11 are taken during one or more time intervals, called “acquisition intervals”, it being understood that each acquisition interval contains a period during which the engine of the aircraft is in operation. By “operation of the engine of the aircraft” reference is here made to the fact that the engine of the aircraft has started. Such a configuration of course covers the taxiing phases before and after landing, the take-off phase, the cruising phase, the landing phase, but also the phases during which the aircraft has not yet left its parking before take-off or has already reached its parking after landing, its engines nevertheless being in operation.

It should be noted that no limitation is attached to the duration of an acquisition interval, or even to the number of acquisition intervals that can be envisaged. In practice, the duration of an acquisition interval is for example defined directly, via the data of said duration in seconds, or even for example indirectly, via the data of a number of rotation cycles of the rotating shaft to be acquired.

It should also be noted that the instants in which the absolute acceleration measurements y_{c}[k] are acquired may or may not differ from the instants in which the rotational speed measurements vᵣ[k′] are acquired. In any case, once measurements of these two magnitudes are acquired during the same acquisition interval, it is of course possible to associate with a given instant comprised in said acquisition interval an absolute acceleration measurement and a rotational speed measurement, for example by means of interpolation techniques.

The monitoring system 10 also includes a monitoring device 12 configured to carry out, in particular from measurements acquired by the acquisition means 11, processing operations making it possible to monitor the state (i.e. to carry out a tracking of the wear) of mechanical components such as bearings and gears on the shaft line of the engine of the aircraft, by implementing a monitoring method according to the invention.

In the present embodiment, the monitoring device 12 is integrated to a computing unit equipping the aircraft and also known as FADEC (Full Authority Digital Engine Control). Said FADEC unit is, in a manner known per se, configured to optimally drive and regulate the operation of the engine. However, and unlike a FADEC unit of the state of the art, the FADEC unit described here also makes it possible, because the monitoring device 12 is integrated therein, to monitor the state of the mechanical components such as bearings and gears on the shaft line.

The choice that the monitoring device 12 is integrated to the FADEC unit of the aircraft however constitutes only one variant of implementation of the invention. Thus, nothing excludes having, for example, a processing device 12 external (i.e. not electronically integrated) to the FADEC unit but nevertheless arranged in the aircraft.

FIG. 2 schematically represents one example of hardware architecture of the monitoring device 12 according to the invention belonging to the monitoring system 10 of FIG. 1.

As illustrated in FIG. 2, the monitoring device 12 has the hardware architecture of a computer. Thus, the monitoring device 12 includes, in particular, a processor 1, a random access memory 2, a read only memory 3 and a non-volatile memory 4. It further includes communication means 5.

The read only memory 3 of the monitoring device 12 constitutes a recording medium in accordance with the invention, readable by the processor 1 and on which a computer program PROG in accordance with the invention is recorded, including instructions for the execution of steps of the monitoring method according to the invention. The program PROG defines functional modules of the monitoring device 12, which rely on or control the hardware elements 1 to 5 of the monitoring device 12 mentioned above, and which comprise in particular:
e. a first obtaining module MOD_OBT1 configured to obtain at least one measurement y_{c}[k] of the absolute acceleration of the shaft,
f. a second obtaining module MOD_OBT2 configured to obtain a value fᵣ[k] of the rotational frequency of the shaft for an instant in which said at least one measurement y_{c}[k] was previously acquired,
g. a first determination module MOD_DET1 configured to determine a matrix H[k] making it possible to define a state model described by:

$$x [ k + 1 ] = x [ k ] + w [ k ] and Y [ k ] = [ \begin{matrix}{y}_{c} [ k ] \\ SE [ k ]\end{matrix} ] = H [ k ] \times x [ k ] + v [ k ]$$

where w[k] is a random noise and v[k] is a noise associated with said at least one measurement y_{c}[k], H[k] is defined from the value fᵣ[k], SE[k] is equal to the expectation of the product between y_{c}[k] and the conjugate value of y_{c}[k], x[k] is a vector including, for each mechanical component, a sub-vector whose components are representative of a contribution of said mechanical component to the vector y[k],
a second determination module MOD_DET2 configured to determine an estimator of the vector x[k] from said matrix H[k],
a third determination module MOD_DET3 configured to determine, from said estimator, a quantity characteristic of said contribution associated with a mechanical component,
a comparison module MOD_COMP configured to compare said quantity with a threshold, so as to obtain a comparison result,
a detection module MOD_DETECT configured to detect a possible defect of said at least one mechanical component based on the comparison result,
an alert module MOD_ALERT configured to issue an alert if a defect is detected for a mechanical component.

The communication means 5 are configured to allow the monitoring device 12 to communicate, in particular, with the acquisition means 11, so as to be able to directly obtain one or more absolute acceleration and/or rotational speed measurements acquired thereby. For this purpose, the communication means 5 are based on a wired or wireless communication interface able to implement any known protocol (Ethernet, Wifi, Bluetooth, 3G, 4G, 5G, etc.) adapted to an exchange of data between the monitoring device 12 and the acquisition means 11. It is noted that, in this exemplary embodiment, the communication means 5 integrate said first obtaining module MOD_OBT1. Of course, the acquisition means 11 are themselves provided with communication means adapted to the transmission of one or more absolute acceleration and/or rotational speed measurements.

In the present embodiment, the second obtaining module MOD_OBT2 is also integrated to said communication means 5 and each value fᵣ[k] of the rotational frequency of the shaft is determined by the acquisition means 11 themselves from the acquired rotational speed measurements. In other words, in the embodiment described here, the monitoring device 12 obtains for each measurement y_{c}[k] of the absolute acceleration of the shaft a value fᵣ[k] of the rotational frequency of said shaft, obtaining this value here taking the form of a data exchange between the acquisition means 11 and said second obtaining module MOD_OBT2.

A value of the rotational frequency of the shaft on which a sensor dedicated to the rotational speed measurements vᵣ[k′] is fixed can be determined using any technique known to those skilled in the art.

For example, and initially, the rotational speed signal can be analyzed to determine its nature. It can indeed be a square or sinusoidal signal or even a series of pulses. From this analysis, it is then possible, in a second step, to implement an algorithm making it possible to estimate the rotational frequency of the reference shaft. Such an algorithm can be broken down into three variants of implementation: the first variant is based on a detection of the instants of the rising edges when the signal from the speed sensor is square; the second variant is based on an estimation of the instantaneous frequency of the sinusoidal signal; the third variant is based on a time location of peaks when the signal from the speed sensor is a series of pulses.

It should be noted that the choice according to which a value of the rotational frequency is determined by the acquisition means 11 in association with each measurement y_{c}[k] of the absolute acceleration of the shaft constitutes only one exemplary embodiment of the invention.

Other variants of embodiment can nevertheless be envisaged. For example, the processing operations making it possible to determine one or more values of the rotational frequency can be implemented by the monitoring device 12 once the latter has been obtained, from the acquisition means 11, the acquired rotational speed signal. It is then understood that, for this variant of embodiment, the obtaining module MOD_OBT2 has the function of implementing said processing operations.

Nothing excludes envisaging that each value fᵣ[k] of the rotational frequency of the shaft is determined from a signal of the rotational speed of the shaft determined other than by means of one or more speed sensors, for example directly from an aircraft engine control signal. In this way, the use of such speed sensors is not required and the obtaining module MOD_OBT2 can either be used to receive the values fᵣ[k] of the rotational frequency of the shaft once they are determined from said control signal, or to itself determine said values fᵣ[k] from said control signal communicated thereto.

In general, no limitation is attached to the way in which the monitoring device 12 can obtain one or more values of the rotational frequency of the shaft.

For the rest of the description, and for the purpose of simplifying it only, it is considered without limitation that the mechanical components present on the shaft correspond to a gear formed of two meshed wheels as well as to a bearing.

It is also considered purely by way of illustration that the monitoring method, for this particular mode, is implemented during a flight of the aircraft, more particularly during a cruising phase.

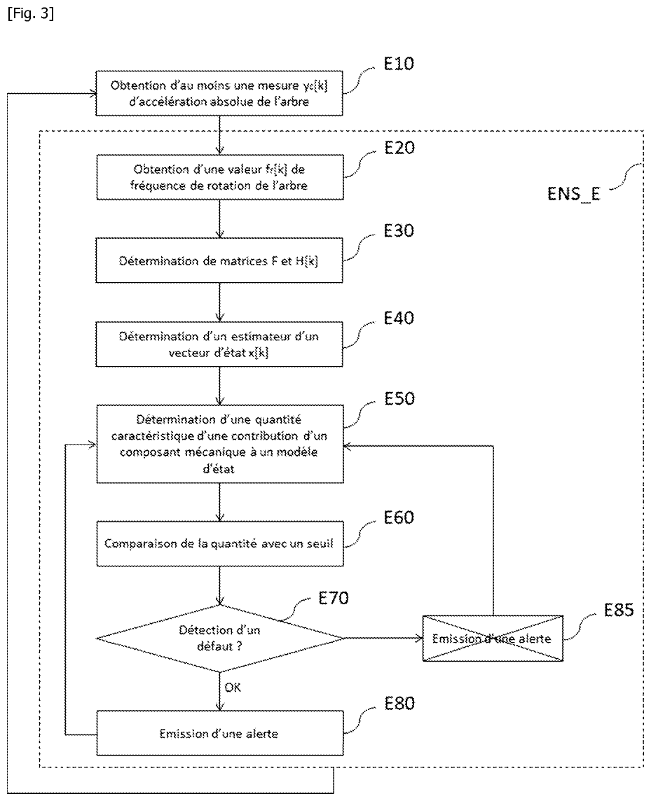

FIG. 3 represents, in the form of a flowchart, one particular mode of implementation of the monitoring method according to the invention. The steps of said particular mode of implementation are executed by the monitoring device 12 of FIG. 2.

In the present mode of implementation, it is considered that measurements y_{c}[k] of the absolute acceleration of the shaft are acquired recurrently, for example periodically, by the acquisition means 11 and that each measurement y_{c}[k] is transmitted to the monitoring device 12 immediately after its acquisition.

As illustrated in FIG. 3, the monitoring method includes, for each measurement y_{c}[k] of the absolute acceleration of the shaft acquired by the acquisition means 11, a step E10 of obtaining said measurement y_{c}[k]. Said step E10 is implemented by the first obtaining module MOD_OBT1 equipping the monitoring device 12.

In the present mode of implementation, the monitoring method also includes, after each time a measurement y_{c}[k] of the absolute acceleration is obtained, a set ENS_E of steps.

The rest of the description aims to describe the steps comprised in said set ENS_E for a measurement y_{c}[k] of the absolute acceleration previously acquired and obtained following the execution of step E10. It should be noted that said steps of the set ENS_E are intended to be executed iteratively after each time a measurement of the absolute acceleration of the shaft is obtained by the monitoring device 12.

As illustrated in FIG. 3, said set ENS_E of steps firstly includes a step E20 of obtaining a value fᵣ[k] of the rotational frequency of the shaft for the instant in which said measurement y_{c}[k] was previously acquired. Said step E20 is implemented by the second obtaining module MOD_OBT2 equipping the monitoring device 12.

As mentioned previously, said value fᵣ[k] of the rotational frequency of the shaft is determined by the acquisition means in correspondence with said measurement y_{c}[k] (the correspondence relating here to the instant of acquisition of said measurement y_{c}[k]), so that obtaining the value, which is the subject of step E20 refers, in the present mode of implementation, to a transmission of data between the acquisition means 11 and the monitoring device 12.

It should be noted that steps E10 and E20 are described in the present mode of implementation as being executed one after the other. Of course, this is only an optional implementation, and nothing excludes envisaging that these steps E10 and E20 are executed in parallel.

Once the value fᵣ[k] of the rotational frequency of the shaft has been obtained, the set ENS_E of steps also includes a step E30 of determining a matrix H[k] making it possible to define said state model. Said step E30 is implemented by the first determination module MOD_DET1 equipping the monitoring device 12.

The matrix H[k] describes the variations in signatures of the state of health of the mechanical components placed on the rotating shaft, said state-of-health signatures being implicitly contained in the state vector of the state model as this is detailed later.

It should be noted that the state model according to the invention relates not only to the acceleration signal y_{c}, but also to the signal SE that corresponds to the expectation of the product between said signal y_{c} and the conjugate value of said signal y_{c} (equivalently, the signal SE corresponds to the square of the envelope of the acquired signal y_{c}). Thus, the state model can be seen as a dynamic modeling of an “augmented” signal corresponding to the pooling, in the form of a vector denoted here Y, of samples of the acceleration signal y_{c} and of said signal SE. Considering such a state model advantageously makes it possible to simultaneously monitor the state of health of the gears and bearings.

The monitoring method proposed by the invention is therefore based on the use of the state model that makes it possible to represent (model) the respective contributions of the mechanical components of the shaft line to the vibrations undergone by the rotating shaft during the operation of the rotating machine.

More specifically, the contributions associated with the gear-type mechanical components are at the level of the component y_{c}[k] of the vector Y[k], while the contributions associated with bearing-type components are at the level of the component SE[k] of said vector Y[k]. In other words, the vector Y[k] forms a representation of the kinematics of the mechanical components whose state should be monitored.

Such an approach to modeling the vibration behavior of the shaft, and therefore a fortiori of the mechanical components that equip it, advantageously makes it possible to carry out said monitoring regardless of the rotational speed of the shaft. It is further independent of the operating rpm of the rotating machine, and can therefore be implemented in the case of a variable rpm.

An example of determination of said matrix H[k] is now described here in detail. To this end, it is first noted that the vibration signal, denoted y_{c}, provided by an acceleration sensor can be broken down according to the expression below:

y_{c}[k]=yᵣ[k]+y_{g}[k]+b[k]

expression in which yᵣ is the vibration signal generated by the bearing, called “bearing signal”, y_{g} is the signal generated by the contact between gear wheels, called “meshing signal”, and b is the measurement noise which represents the vibrations from other members of the engine.

The meshing signal y_{g} can be written as follows:

$${y}_{g} [ k ] = {\sum }_{m = 1}^{M} {a}_{m} [ k ] {e}^{J ( {θ}_{m} [ k ] + {ϕ}_{m} [ k ] )}$$

expression in which:
M is the number of harmonics of the meshing components (frequencies). Said number M is determined beforehand;
aₘ[k] and ϕₘ[k] are respectively the amplitude and phase modulations of the m^{th} meshing component;
θₘ[k] is the instantaneous phase of the meshing of the m^{th} meshing component and is written:

$${θ}_{m} [ k ] = 2 π {t}_{e} \times Z \times m {\sum }_{i = 1}^{k} {f}_{r} [ j ]$$

where fᵣ is the rotational frequency of the shaft, Z is the cyclic order of the meshing frequency (i.e. the ratio between the contact frequency between two teeth of the gear wheels and that of the rotating shaft), to is the sampling period (i.e. the inverse of the sampling frequency fₑ).

Given the analytical expression of the meshing signal y_{g}, the vibration signal y_{c} can still be written as follows:

$${y}_{c} [ k ] = {\sum }_{m = 1}^{M} {\tilde{a}}_{m} [ k ] {e}^{j {θ}_{m}} + {v}_{1} [ k ]$$

with ãₘ[k]=aₘ[k]e^{jϕ}^{ₘ}^{[k]} which corresponds to the complex envelope of the carrier e^{jθ}^{ₘ}^{[k]} and v₁ which corresponds to the measurement noise containing the vibration signal of the bearings and that of the other portions of the system. The complex envelope ãₘ[k] is characteristic of the state of the wheels of the gear. The diagnosis of the latter therefore amounts to estimating and analyzing this complex envelope ãₘ[k].

The presence of a defect on one of the wheels of a gear is manifested by a periodicity of the complex envelope. This periodicity is equal to that of the rotation of the faulty wheel. From an analytical point of view, the complex envelope ãₘ[k] can be approximated by a Fourier series. By defining θᵣ[k] as being equal to the ratio between θₘ[k] and the quantity Z×m (θᵣ[k] thus corresponds to the angular displacement of the rotating shaft), the complex envelope ãₘ[k] can be written as follows:

$$\begin{matrix}{\tilde{a}}_{m} [ k ] = {\sum }_{n = - {N}_{b}}^{{N}_{b}} {α}_{m , n} [ k ] {e}^{jn {o}_{r 1} {θ}_{r 1} [ k ]} + {β}_{m , n} [ k ] {e}^{jn {o}_{r 2} {θ}_{r} [ k ]} \\ = {b}^{T} [ k ] {p}_{m} [ k ]\end{matrix}$$

expression in which:
N_{b} is the maximum number of lateral lines (bands) around the meshing frequencies. Said number N_{b} is determined beforehand;
oᵣ₁ and oᵣ₂ are respectively the cyclic orders of the rotational frequency of the first and the second wheel of the gear;
α_{n,m} AND β_{n,m} are the Fourier coefficients;
b[k] is a vector that can be written:

b[k]=(bᵣ₁^{T}[k]bᵣ₂^{T}[k])^{T}∈ [symbol] ^{2(2N}^{_{b}}^{+1)×1}
where bᵣ₁[k] is equal to

(e^{-jN}^{_{b}}^{o}^{ᵣ₁}^{θ}^{ᵣ}[k] . . . e^{-jo}^{ᵣ₁}^{θ}^{ᵣ}^{[k]}1e^{jo}^{ᵣ₁}^{θ}^{ᵣ}^{[k]} . . . e^{jN}^{_{b}}^{o}^{ᵣ₁}^{θ}^{ᵣ}^{[k]})^{T}∈ [symbol] ^{(2N}^{_{b}}^{+1)×1}

and bᵣ₂[k] is equal to

(e^{-jN}^{_{b}}^{o}^{ᵣ₂}^{θ}^{ᵣ}^{[k]} . . . e^{-jo}^{ᵣ₂}^{θ}^{ᵣ}^{[k]}1e^{jo}^{ᵣ₂}^{θ}^{ᵣ}^{[k]} . . . e^{jN}^{_{b}}^{o}^{ᵣ₂}^{θ}^{ᵣ}^{[k]})^{T}∈ [symbol] ^{(2N}^{_{b}}^{+1)×1};
pm[k] is a vector that can be written:

pₘ[k]=(p_{m,r1}^{T}p_{m,r2}^{T})^{T}∈ [symbol] ^{2(2N}^{_{b}}^{+1)×1}

where p_{m,r1}[k] is equal to (α_{m,-N}_{_{b}} . . . α_{m,N}_{_{b}})^{T}∈ [symbol] ^{(2N}^{_{b}}^{+1)×1} and p_{m,r2}[k] is equal to (β_{m,-N}_{_{b}} . . . β_{m,N}_{_{b}})^{T}∈ [symbol] ^{(2N}^{_{b}}^{+1)×1}.

It follows that the vibration signal y_{c} admits the following expression:

$$\begin{matrix}{y}_{c} [ k ] = {\sum }_{m = 1}^{M} {b}^{T} [ k ] {p}_{m} [ k ] {e}^{j {θ}_{m} [ k ]} + {v}_{1} [ k ] \\ = {c}_{e}^{T} [ k ] {x}_{e} [ k ] + {v}_{1} [ k ]\end{matrix}$$

expression in which:
cₑ[k] is equal to (b^{T}[k]e^{jθ}^{₁}^{[k]} . . . b^{T}[k]e^{jθ}^{_{M}}^{[k]})^{T}∈ [symbol] ^{2M(2N}^{_{b}}^{+1)×1}. It is the vector of the carriers;
xₑ[k] is equal to (p₁^{T}[k] . . . p_{M}^{T}[k])^{T}∈ [symbol] ^{2M(2N}^{_{b}}^{+1)×1}. It is the vector that contains the coefficients of the Fourier series approaching the complex envelope ãₘ[k] du meshing signal y_{g}.

The estimation of the complex envelope ãₘ[k] is reduced to the estimation of its Fourier coefficients contained in the variable xₑ. This estimation is made by taking into account the possible variation of the Fourier coefficients in variable rpm. Thus, in this exemplary implementation, it is assumed that the Fourier coefficients, and therefore the variable xₑ, vary according to a random walk given by the following expression:

xₑ[k+1]=xₑ[k]+wₑ[k]

expression in which wₑ[k] is a random signal of any statistical nature.

Ultimately, the relations given above for y_{c}[k] and xₑ[k] form the model of the meshing signal. Thanks to this model, the real-time monitoring of the gear is reduced to estimating the Fourier coefficients of the complex envelope ãₘ[k] of the meshing signal y_{g}.

The analytical model of the meshing signal y_{g} has been discussed so far. Also, an analytical model of the bearing signal yᵣ is now presented so as to be finally able to give an analytical model of the signal SE[k] and then express the matrix H[k] that forms the state model according to the invention.

The vibration generated by the bearing placed on the shaft can be written according to the following expression:

$${y}_{r} [ k ] = κ ( ω [ k ] ) M [ k ] {\sum }_{i = 1}^{d} {A}_{i} I [ k - ⌈ {T}_{i} {f}_{e} ⌉ ]$$

expression in which:
M[k] is the load distribution function when the inner ring of the bearing is subjected to a radial load. Under stationary conditions, it is known that this distribution function is periodic, with a period equal to that of the rotation of the reference shaft. For more details concerning these aspects, those skilled in the art can for example refer to the document: “Cyclic spectral analysis of rolling-element bearing signals: Facts and fictions”, J. Antoni, Journal of Sound and Vibration 304, 2007, 497-529;
κ(ω[k]) is a modulation function that depends on the angular speed ω of the shaft;
Aᵢ is the amplitude of the i^{th} impact. It has a Gaussian distribution comprised between 0 and 1 such that Aᵢ=A+δAᵢ. A is the mean of the distribution and SA, is the random part;
I is the impulse response of the structure of the bearing;
[x] denotes the integer part of the decimal number x;
d is the number of impacts resulting from a possible bearing defect;
Tᵢ is the instant of appearance of the i^{th} impact such that Tᵢ=t(iθ_{d}+δθᵢ) is the angular period of said possible bearing defect and δθᵢ is a centered Gaussian distribution.

The square of the envelope of the vibration signal y_{c}, in other words the signal SE[k], is given by the following expression:

$$\begin{matrix}SE [ k ] = 𝔼 \{ {y}_{c} [ k ] {\overline{y}}_{c} [ k ] \} \\ = 𝔼 \{ ( {y}_{r} [ k ] + {y}_{g} [ k ] + b [ k ] ) ( {\overline{y}}_{r} [ k ] + {\overline{y}}_{g} [ k ] + \overline{b} [ k ] ) \}\end{matrix}$$

where the notation α̅ indicates the conjugate of the complex number α and [symbol] {.} denotes the mathematical expectation.

In the present exemplary implementation, it is assumed that the meshing signal y_{g}, the bearing signal yᵣ, and noise b are mutually uncorrelated. Consequently, the square of the envelope becomes:

SE[k]= [symbol] {yᵣ[k]y̅ᵣ[k]}+n₂[k]

expression in which n₂[k] is equal to [symbol] {y_{g}[k]y̅_{g}[k]}+ [symbol] {b[k]b̅[k]} which is considered as noise of any statistical nature.

The presence of a defect on the bearing is manifested by the fact that the bearing signal yᵣ is cyclical as well as its autocorrelation function. Consequently, the signal SE[k] is cyclical and tainted by noise n₂[k]. From this observation, the signal SE[k] can be approximated by a Fourier series and can be written according to the expression:

$$SE [ k ] = {\sum }_{z = 1}^{l} {µ}_{z} [ k ] cos ( z {θ}_{d} [ k ] + {Φ}_{z} [ k ] ) + {v}_{2} [ k ]$$

expression in which:
μ_{z}[k] and ϕ_{z}[k] are respectively the amplitude and the phase of the z^{th} component of the Fourier series;
l designates the number of lines related to the bearing defect (l represents the number of harmonics of interest in the square of the envelope of the acceleration signal y_{c} for monitoring of the different components of the bearing). Said number l is determined beforehand,
v₂ is a noise of any statistical nature and comprising the noise n₂ and possibly part of the lines related to the bearing defect when l is much lower than the number of significant lines related to the bearing defect.

By a trigonometric transformation, the signal SE[k] can be finally written:

$$SE [ k ] = {\sum }_{z = 1}^{l} {h}_{z}^{T} [ k ] {x}_{z} [ k ] + {v}_{2} [ k ]$$

expression in which:
h_{z}[k] is equal to (cos(zθ_{d}[k]) sin(zθ_{d}[k]))^{T}∈ [symbol] ^{2×1};
x_{z}[k] is equal to (μ_{z}[k] cos(Φ_{z}[k]) μ_{z}[k] sin(Φ_{z}[k]))_{T}∈ [symbol] ^{2×1}.

By grouping the components of the Fourier series, it follows that the signal SE[k] can be put in the following form:

SE[k]=cᵣ^{T}[k]xᵣ[k]+v₂[k]

expression in which:
cᵣ[k] is equal to (h₁^{T}[k] . . . hₗ^{T}[k])^{T}∈ [symbol] ^{2l×1}.
xᵣ[k] is equal to (x₁[k] . . . xₗ[k])^{T}∈ [symbol] ^{2l×1}.

In the same way as for the analytical modeling of the model of the meshing signal y_{g}, it is considered, in the present exemplary implementation, that the coefficients of the Fourier series approaching the signal SE[k] follow a random walk, so that:

xᵣ[k+1]=xᵣ[k]+wᵣ[k]

expression in which wᵣ[k] is finite energy random noise.

From the previous developments, it is now possible to express the state model according to the following expression:

$${\underbrace{[ \begin{matrix}{y}_{c} [ k ] \\ S E [ k ]\end{matrix} ]}}_{Y [ k ]} = {\underbrace{[ \begin{matrix}{c}_{e}^{T} [ k ] & {o}_{1 \times 2 l} \\ {o}_{1 \times 2 {MN}_{b}} & {c}_{r}^{T} [ k ]\end{matrix} ]}}_{H [ k ]} {\underbrace{[ \begin{matrix}{x}_{e} [ k ] \\ {x}_{r} [ k ]\end{matrix} ]}}_{x [ k ]} + {\underbrace{[ \begin{matrix}{v}_{1} [ k ] \\ {v}_{2} [ k ]\end{matrix} ]}}_{v [ k ]}$$

expression in which:
v[k] is a noise associated with said measurement y_{c}[k];
x[k] is a vector, called “state vector”, including, for each mechanical component, a sub-vector (xₑ[k] or xᵣ[k]) whose components are representative of a contribution of said mechanical component to the vector Y[k]. it is noted that the state vector x contains the unknowns of the state model.

It is also possible to express the state vector x in the following way from the previous developments:

$${\underbrace{[ \begin{matrix}{x}_{e} [ k + 1 ] \\ {x}_{r} [ k + 1 ]\end{matrix} ]}}_{x [ k + 1 ]} = {\underbrace{[ \begin{matrix}{I}_{2 {MN}_{b} \times 2 {MN}_{b}} & {o}_{2 {MN}_{b} \times 2 l} \\ {o}_{2 l \times 2 {MN}_{b}} & {I}_{2 l \times 2 l}\end{matrix} ]}}_{F} {\underbrace{[ \begin{matrix}{x}_{e} [ k ] \\ {x}_{r} [ k ]\end{matrix} ]}}_{x [ k ]} + {\underbrace{[ \begin{matrix}{w}_{e} [ k ] \\ {w}_{2} [ k ]\end{matrix} ]}}_{w [ k ]}$$

expression in which w[k] is the state noise of the model, and F represents an identity matrix.
[91] The expressions of y[k] and x[k+1] represent the augmented state model of the vibration signal y_{c}. The estimation of the parameters of this state model, and consequently that of the quantities characteristic of the state of the bearing and the gear wheels, can be determined from these expressions.
[92] Ultimately, once said matrix H[k] has been determined, the monitoring method includes a step E40 of determining an estimator of the vector x[k] from said matrix H[k]. Said step E40 is implemented by the second determination module MOD_DET2 equipping the monitoring device 12.
[93] According to one particular exemplary implementation, the estimator of the vector x[k] is determined by means of a minimax optimization algorithm. More particularly, starting from the expression of the state vector x described previously, a minimax estimator is implemented for a linear combination of the state variable, denoted ŝ[k], and defined as follows:

ŝ[k]=H[k]\hat{x}[k]

expression in which \hat{x}[k] is the robust estimation of the state vector x[k]. Said estimation \hat{x}[k] satisfies the following recursive equation:

\hat{x}[k]=\hat{x}[k−1]+g[k](y[k−1]−H[k−1]\hat{x}[k−1])

expression in which g[k] corresponds to the gain of the estimator.
[94] By noting e[k] the estimation error (i.e. e[k]=s[k]−ŝ[k]), the gain of the minimax estimator can then be determined by minimizing the following quadratic cost function J:

$$J = {e}^{T} [ 1 ] {P}^{- 1} e [ 1 ] + {\sum }_{k = 1}^{n} ( {w}^{T} [ k ] {Q}^{- 1} w [ k ] + {v}^{T} [ k ] {R}^{- 1} v [ k ] ) - γ {\sum }_{k = 1}^{n} {e}^{T} [ k ] e [ k ]$$

expression in which the function J is strictly positive and P[1], Q and R are positive diagonal weighting matrices respectively for the initialization error e[1], the state noise w[k] and the measurement noise v[k] (such matrices, and more particularly their respective settings, are known to those skilled in the art). In the present exemplary implementation, said cost function J is minimized for the worst case scenario, which amounts to minimizing J with respect to ŝ[k] and maximizing J with respect to e[1], w[k] and v[k]. This leads to a minimax optimization formulated as follows:

$${\{ \hat{s} [ k ] \}}_{k = 1}^{n} = arg ( {min}_{\hat{s}} {max}_{e [ 1 ] , w , v} J )$$

[95] Such an optimization problem can be solved by a Lagrange multiplier approach, so as to obtain the following expression for the gain g[k]:

g[k]=P[k]Γ[k−1]H^{T}[k]R⁻¹

expression in which:
P is a positive definite symmetric matrix which satisfies the following Riccati equation:

P[k]=P[k−1]Γ[k−1]+Q
Γ[k] is given by the following expression:

Γ[k]=(I_{(2MN}_{_{b}}_{+2l)×(2MN}_{_{b}}₊₂l)−γH^{T}[k]H[k]P[k]+H[k]R⁻¹H^{T}[k]P[k])⁻¹

where γ is strictly less than Sup R⁻¹ (“Sup” defines the supremum of the inverse of the weighting matrix R).

For more details concerning the minimax optimization formulated in this exemplary implementation and obtaining the gain g[k], those skilled in the art can refer to the document “Discrete H-infinity filter design with application to speech enhancement”, Shen, X., ICASSP, vol 2, page 1504-1507, 1995.

It is important to note that nothing excludes envisaging, according to other exemplary implementations of step E40 of the monitoring method, a determination of said estimator by means of an algorithm other than said minimax optimization algorithm. For example, a least squares optimization algorithm can be used.

Once the estimator of the vector x[k] has been determined, it is possible to detect a possible defect in each of the mechanical components placed on the shaft of the aircraft engine. To this end, in the mode of implementation of FIG. 3, the set ENS_E of steps includes, for each of said mechanical components, a plurality of steps.

For the record, the mechanical components arranged on the shaft include, in the present mode of implementation, a bearing and a gear formed of two meshed wheels. Also, for the rest of the description, said plurality of steps of the set ENS_E is initially executed and described for said bearing. It is nevertheless understood that this is a purely an arbitrary choice, and that said plurality of steps could just as well be executed initially for said gear.

As illustrated by FIG. 3, said plurality of steps includes, initially, a step E50 of determining, from said estimator of the vector x[k], a quantity Q_R characteristic of the contribution of said bearing to the vector Y[k]. Said step E50 is implemented by the third determination module MOD_DET3 equipping the monitoring device 12.

Said quantity Q_R more particularly characterizes the state of health of said bearing. It is obtained from said contribution of the bearing, in other words, by taking up the exemplary implementation described above for step E30, from the sub-vector xᵣ[k] comprised in the state vector x[k]. In the present exemplary implementation, said contribution of the bearing corresponds to an estimation of the signal SE[k]. It is noted that such an estimation is accessible thanks to the estimator of the state vector x[k] previously obtained (step E40), and which a fortiori also provides an estimator of said sub-vector xᵣ[k], so that it is possible to determine said quantity Q_R.

By way of non-limiting example, said quantity Q_R is representative of an energy of the signal SE[k].

However, nothing excludes envisaging a quantity Q_R of another type, such as a phase or energy of said contribution of the bearing.

Said plurality of steps also includes a step E60 of comparing said quantity Q_R determined for said bearing with a threshold S_R, so as to obtain a comparison result. Said step E60 is implemented by the comparison module MOD_COMP equipping the monitoring device 12.

In practice, said comparison result corresponds to an information data indicating whether the quantity Q_R is greater than or less than said threshold S_R, and from which it is possible to detect a possible defect in the bearing.

It is noted that the threshold S_R can for example be determined by an expert and recorded in storage means of the monitoring device 12 (for example in the non-volatile memory 4) or, according to another example, correspond to a quantity Q_R determined during a previous implementation of the monitoring method according to the invention and in which no defect in the bearing has been detected.

For this purpose, said plurality of steps of the set ENS_E also includes a step E70 of detecting a possible defect in the bearing based on the comparison result obtained following the implementation of step E60. Said step E70 is implemented by the detection module MOD_DETECT equipping the monitoring device 12.

Thus, in the present mode of implementation, a defect in the bearing (respectively an absence of defect in the bearing) is detected if the quantity Q_R is higher (respectively lower) than the threshold S_R. Such detection is based here on a comparison between numerical quantities (quantities Q_R and S_R). In other words, at this stage of the monitoring method, the information that the state of health of the bearing may not be compliant corresponds to digital information, typically encoded in the form of bits.

Also, in the present mode of implementation, said plurality of steps of the set ENS_E further includes a step E80 of issuing an alert if a defect in the bearing is detected. Said step E80 is implemented by the alert module MOD_ALERT equipping the monitoring device 12.

Said alert corresponds for example to a sound signal, to a light signal, etc., this signal being able to be transmitted to an operator on the ground in charge of the maintenance of the aircraft and/or to the cockpit of the aircraft in order to alert the flight crew.

The communication with the user (operator on the ground or flight crew for example) on the state of the monitoring system 10 can moreover take place in the form of a graph projected by display means dedicated for this purpose (screen for example).

It is noted that if no defect is detected, then, of course, no alert is issued (step E85 in FIG. 3).

Subsequently, steps E50 to E70, as well as E80 or E85, are iterated for the gear arranged on the shaft. For this purpose, a quantity Q_E characteristic of the contribution of said gear to the vector Y[k] is determined (this is, in the present exemplary implementation, the amplitude or the phase or the energy of the complex envelope ãₘ[k], this quantity Q_E then being compared with a threshold S_E to detect a possible defect in the gear.

Although the steps E50 to E70, as well as E80 or E85, have been described so far as being implemented successively for each of the mechanical components arranged on the shaft, the fact remains that the invention also covers the case where these steps are implemented in parallel for each of said components.

Furthermore, if it is considered in the mode of implementation of FIG. 3 that steps E50 to E70, as well as E80 or E85, are executed for all the mechanical components arranged on the shaft, it is also possible to envisage other modes of implementation in which only part of said mechanical components is concerned by these steps.

The invention has been described so far considering that the monitoring device 12 is arranged in the aircraft. Nothing, however, excludes envisaging that the latter is disposed on the ground and that it communicates with the acquisition means arranged in the aircraft by means of any protocol known to those skilled in the art.

Furthermore, the monitoring method has also been described by considering a mode of implementation in which the steps of the set ENS_E are executed after each time the monitoring device 12 receives a measurement of the absolute acceleration y_{c}[k]. The monitoring method nevertheless remains applicable in the case where the monitoring device stores a plurality of absolute acceleration measurements (after their receipt from the acquisition means 11), then only then implements the steps of the set ENS_E for each of the thus stored measurements.

The monitoring method has also been described by considering a mode of implementation in which an alert is issued if a defect is detected. Nothing however excludes envisaging that no alert is issued by the monitoring device 12, but that the detection results are analyzed (in real time or in a deferred manner) by an expert who can therefore decide whether it is necessary to validate or not a defect detection carried out by the monitoring device 12.

It is also noted that if the mode of implementation of FIG. 3 does not include the acquisition as such of measurements useful for the monitoring of the state of health of the mechanical components placed on the shaft, it nevertheless remains possible to envisage other modes in which measurements can be acquired during one or more steps (step of acquiring at least one measurement y_{c}[k] and/or step of acquiring a rotational speed vᵣ[k′] for example) of said monitoring method. In this case, the monitoring method is no longer implemented by the monitoring device 12 alone, but also by all or part of said acquisition means 11.

Finally, it should be noted that, more generally, the implementation of the present invention is not limited to the sole field of aeronautics. It indeed remains applicable for any type of rotating machine, regardless of the technical field concerned, such as electric motors, power transmission motors, electromechanical actuators, wind turbines, gear axles, etc.

1. A method for monitoring the state of mechanical components such as bearings and gears on a shaft line equipping a rotating machine, said method comprising:
obtaining at least one measurement y_{c}[k], k being an integer index, of the absolute acceleration of the shaft in a fixed reference frame related to the rotating machine, as well as a set of steps of:
obtaining a value fᵣ[k] of the rotational frequency of the shaft for an instant in which said at least one measurement y_{c}[k] was previously acquired,
determining a matrix H[k] making it possible to define a state model described by:
$$x [ k + 1 ] = x [ k ] + w [ k ] etY [ k ] = [ \begin{matrix}{y}_{c} [ k ] \\ SE [ k ]\end{matrix} ] = H [ k ] \times x [ k ] + v [ k ]$$
where w[k] is a random noise and v[k] is a noise associated with said at least one measurement y_{c}[k], H[k] is defined from the value fᵣ[k], SE[k] is equal to the expectation of the product between y_{c}[k] and the conjugate value of y_{c}[k], x[k] is a vector including, for each mechanical component, a sub-vector whose components are representative of a contribution of said mechanical component to the vector Y[k],
determining an estimator of the vector x[k] from said matrix H[k],
said set of steps further including, for at least one mechanical component, steps of:
determining, from said estimator, a quantity characteristic of said contribution associated with said mechanical component,
detecting a possible defect of said at least one mechanical component based on a comparison of said quantity with a threshold.

2. The method according to claim 1, wherein the estimator of the vector x[k] is determined by means of a minimax optimization algorithm or a least squares optimization algorithm.

3. The method according to claim 1, wherein said quantity is representative of an amplitude or a phase or an energy of said contribution.

4. The method according to claim 1, said method further including, if a defect is detected, a step of issuing an alert.

5. The method according to claim 1, wherein a plurality of absolute acceleration measurements are obtained recurrently, said set of steps being implemented after each time an absolute acceleration measurement is obtained.

6. A non-transitory computer-readable medium having stored thereon instructions which, when executed by a processor, cause the processor to implement the method of claim 1.

7. (canceled)

8. A device for monitoring the state of mechanical components such as bearings and gears on a shaft line equipping a rotating machine, said processing device including:
a first obtaining module configured to obtain at least one measurement y_{c}[k], k being an integer index, of the absolute acceleration of the shaft in a fixed reference frame related to the rotating machine,
a second obtaining module configured to obtain a value fᵣ[k] of the rotational frequency of the shaft for an instant in which said at least one measurement y_{c}[k] was acquired,
a first determination module configured to determine a matrix H[k] making it possible to define a state model described by:
$$x [ k + 1 ] = x [ k ] + w [ k ] e t Y [ k ] = [ \begin{matrix}{y}_{c} [ k ] \\ SE [ k ]\end{matrix} ] = H [ k ] \times x [ k ] + v [ k ]$$
where w[k] is a random noise and v[k] is a noise associated with said at least one measurement y_{c}[k], H[k] is defined based on the value fᵣ[k], SE[k] is equal to the expectation of the product between y_{c}[k] and the conjugate value of y_{c}[k], x[k] is a vector including, for each mechanical component, a sub-vector whose components are representative of the contribution of said mechanical component to the vector Y[k],
a second determination module configured to determine an estimator of the vector x[k] from said matrix H[k],
a third determination module configured to determine, from said estimator, at least one quantity characteristic of said contribution associated with a mechanical component,
a comparison module configured to compare said at least one quantity with a threshold, so as to obtain a comparison result,
a detection module configured to detect a possible defect of said at least one mechanical component based on the comparison result.

9. A system for monitoring the state of mechanical components such as bearings and gears on a shaft line equipping a rotating machine, said monitoring system including:
means for acquiring at least one measurement y_{c}[k], k being an integer index, of the absolute acceleration of the shaft in a fixed reference frame related to the rotating machine,
a monitoring device according to claim 8.

10. An aircraft including a monitoring system according to claim 9.
